(19) United States
(12) Patent Application Publication
(10) Pub. No.: US 2011/0078714 A1
(43) Pub. Date: Mar. 31, 2011

(54) SYSTEM AND METHOD OF SHARING VIDEO ON DEMAND CONTENT

(75) Inventors: Maria M. SAGAYARAJ, Chennai (IN); Srinivas X. WUDALI, Chennai (IN); Ramprasath X. HARIHARAN, Chennai (IN); Ganesh X. RAMASAMY, Chennai (IN); Narayanadhoss X. GOPALAKRISHNAN, Chennai (IN)

(73) Assignee: Verizon Patent and Licensing Inc., Basking Ridge, NJ (US)

(21) Appl. No.: 12/567,237

(22) Filed: Sep. 25, 2009

(51) Int. Cl. H04N 7/16; G06F 13/00; H04N 7/173

(52) U.S. Cl. 725/5; 725/61; 725/97

(57) ABSTRACT

A system for and method of sharing Video on Demand content is presented. The system and method may facilitate sharing of Video on Demand (“VOD”) content between friends and family. The sharing of VOD content between users may allow for the users to view the content in a more cost-effective manner than if the VOD content was purchased individually by all the users. Further, giving users the ability to share VOD content between one another may result in more overall viewing of the content.

### BACKGROUND INFORMATION

Some conventional Video on Demand (“VOD”) systems and methods provide ways of recommending certain VOD content to other VOD subscribers. Also, some conventional VOD systems provide ways of providing VOD content to other subscribers in the form of a gift. Conventional VOD systems do not provide a user with a cost-effective way of sharing VOD content with a fellow subscriber.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 illustrates a system for sharing VOD content, in accordance with exemplary embodiments;

FIG. 2 is a block diagram illustrating exemplary modules of a hardware component of a system for Video on Demand sharing in accordance with exemplary embodiments;

FIG. 3(a) illustrates the appearance of a main menu of a user interface according to a particular embodiment;

FIG. 3(b) illustrates the appearance of a user interface for inputting intended recipients of VOD content according to a particular embodiment;

FIG. 3(c) illustrates the appearance of a VOD recipient messaging interface in accordance with exemplary embodiments;

FIG. 4 is a flowchart illustrating a method of sharing Video on Demand content in accordance with an exemplary embodiment.

### DETAILED DESCRIPTION OF PREFERRED EMBODIMENTS

A system and method in accordance with exemplary embodiments may facilitate sharing of Video on Demand (“VOD”) content between friends and family. The sharing of VOD content between users may allow for the users to view the content in a more cost-effective manner than if the VOD content were purchased individually by all the users. Further, giving users the ability to share VOD content between one another may result in more overall viewing of the content.

The description below describes servers, set top boxes (STBs), display devices, and network elements that may include one or more modules, some of which are explicitly shown in the figures, others that are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, STBs, display devices, and network elements, etc.) separately. The functions described as being performed at various components may be performed at other components, and the various components may be combined and/or separated. Other modifications also may be made.

The terms “recipient” or “intended recipient” as used throughout this description, refer to an individual that the original purchaser of VOD content shared or intended to share the VOD content with.

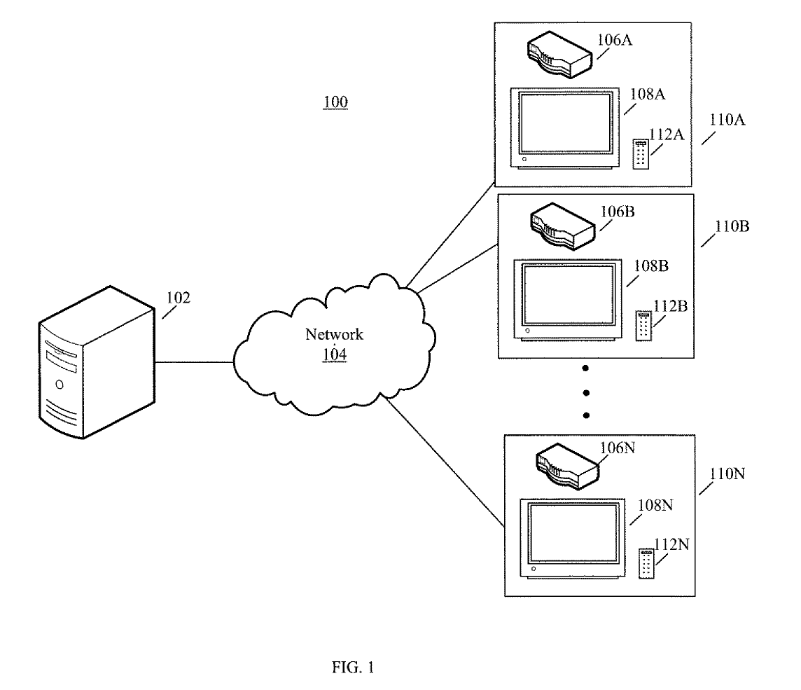

FIG. 1 illustrates a system for sharing VOD content, in accordance with exemplary embodiments. The system 100 may provide the user with different graphical user interfaces to facilitate the sharing process. The system 100 can facilitate the selection of individuals to share the VOD content with. For example, the system 100 may allow for the names of the recipients to be input into a graphical user interface (GUI) by the purchaser of the VOD content and may further allow the purchaser to search, via an internal database or other search mechanism, for potential recipients of purchased VOD content. The system may also communicate to the recipient of the VOD content that the content has been shared with them and is available for viewing.

In exemplary embodiments, the system 100 may include a server 102 communicatively coupled to a network 104, and one or more STBs 106 communicatively coupled to the network 104. The network 104 may communicate content signals from the server 102 to the STBs 106. The server 102 may communicate the content signal to the STBs 106 via the network 104 individually or to the STBs 106 as a group or sub-group. The STBs 106 may be located at one or more user premises 110. In an exemplary embodiment, the server 102 may broadcast, multicast, and/or unicast the content signal.

The content signals may be, for example, television signals or audio signals that may be in digital or analog form, data, requests, other digital or analog information, or combinations thereof. The content signal also may include a plurality of channels, where the STB 106 may tune to a particular channel to display the video of the channel at a display device 108, as is well known in television systems. Additionally, the viewer may use a user input device 112 (e.g., remote control, computer keyboard, computer mouse, touchscreen, etc.) to control which channel the STB 106 causes display of the content at the display device 108. The content signal may be used to display content at the display device 108. Content may be video, audio, text, or other types of video or audio information. It is noted that the input device 112 may be integrated in either the STB 106, the display device 108, or both.

In an exemplary embodiment, the content signal may be a cable television signal complying with the American National Standard Society of Cable Telecommunication Engineers standard ANSI/SCTE 07 2006 titled “Digital Transmission Standard for Cable Television,” the contents of which are incorporated herein by reference in its entirety. The content signal also may comply with other standards and may be communicated by the network 104.

The network 104 may be a wired network, a wireless network, and/or combinations thereof. The network 104 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11 g or any other wired or wireless network for transmitting and/or receiving a data signal. In addition, network 104 may include, without limitation, telephone line, fiber optics, IEEE Ethernet 802.3, a wide area network (“WAN”), a local area network (“LAN”), or a global network such as the Internet. Also, network 104 may support, an Internet network, a wireless communication network, a cellular network, or the like, or any combination thereof. Network 104 may further include one, or any number of the exemplary types of networks mentioned above operating as a stand-alone network or in cooperation with each other. Network 104 may utilize one or more protocols of one or more network elements to which it is communicatively coupled. Network 104 may translate to or from other protocols to one or more protocols of network devices. Although network 104 is depicted as one network, it should be appreciated that according to one or more embodiments, network 104 may comprise a plurality of interconnected networks, such as, for example, a service provider network, the Internet, a broadcaster's network, a cable television network, corporate networks, and home networks.

The network 104 may transport the content signal or various messages in analog or digital form from the server 102 to the STBs 106. The network 104 also may transport analog or digital messages from the STBs 106 to the server 102. In an exemplary embodiment, at least a portion of the network 104 may comply with the Telecommunication Union Telecommunication Standard (ITU-T) Recommendation G.983.1 titled “Broadband Optical Access Systems based on Passive Optical Networks (PON),” January 2005, the contents of which are incorporated herein by reference in its entirety. The network 104 also may comply with other standards. In an exemplary embodiment, the network 104 may communicate with the STBs 106 using three separate carriers, where one of the carriers may exchange data using a data communication session, such as, but not limited to, Internet Protocol, another carrier may communicate content signals to the STBs 106, and the last carrier may receive messages from the STBs 106. The network 104 also may be or include a cable television network, a satellite network, fiber optics, combinations thereof, or other networks capable of distributing a content signal from the server 102 to the STB 106, and exchanging information, messages, requests, etc., between the server 102 and one or more STBs 106 via the network 104.

The user premises 110A-N may each include a STB 106 and a display device 108. FIG. 1 illustrates a STB 106A and a display device 108A at user premises 110A, and a STB 106N and a display device 108N at user premises 110N. In an exemplary embodiment user premises 110A and the devices included therein may correspond to the purchaser or sharer of VOD content. User premises 110B-N may correspond to the recipient of VOD content.

A single user premise 110 may include multiple STBs 106 and multiple display devices 108. The STB 106 also may be remotely located from the display device 108.

In an exemplary embodiment, the STB 106 may be a hardware device that may receive a content signal from the network 104, may cause display of the content signal at the display device 108, and may communicate messages to the network 104. For example, the STB 106 may cause display of a cable television signal at the display device 108, which may be, for example, a television set or computer monitor. In another example, the STB 106 may be a computer and the display device 108 may be a computer monitor. It is noted that the STB 106 and the display device 108 are depicted and described as being separate devices in FIG. 1. The STB 106 and the display device 108, however, may be combined into a single unit. The functions performed by the STB 106 and the display device 108 also may implemented in a mobile phone, a wireless device, or any other device that may communicate via the network 104.

It is noted that system 100 illustrates a simplified view of various components included in a content distribution system, and that other hardware devices and software not depicted may be included in the system 100. It is also noted that the system 100 illustrates only a single server 102 and a single network 104. It will be appreciated that multiple instances of these devices may be used.

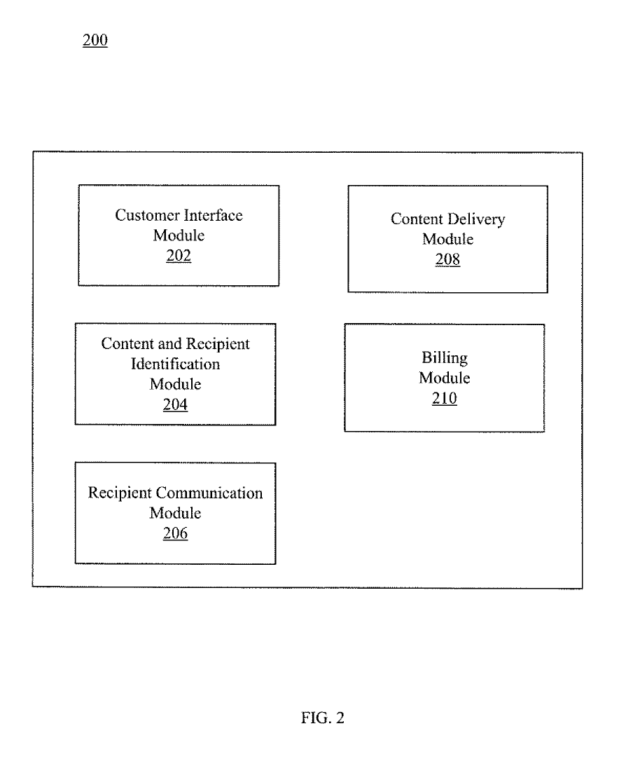

FIG. 2 is a block diagram illustrating exemplary modules of a hardware component of a system for Video on Demand sharing in accordance with exemplary embodiments. The server 102 may receive a request for VOD content from user premises 110A. Specifically, the server 102 may receive information sent from STB 106A and transmitted over network 104 before arriving at the server 102. The server 102 may generate and communicate the content signal to the STB 106 via the network 104.

In some embodiments, this request for VOD content may include information specifically identifying the additional user premises that the VOD content is to be delivered to. In some embodiments, the request for VOD content may include information which may not directly identify the additional user premises to receive VOD content, but which may be processed by server 102 to determine a network address corresponding to the intended recipient premises. The server may send video data content to the multiple premises based on these requests. The server 102 may be configured to utilize the information included in the content request from premises 110A to determine the total charge for the content delivered. The server 102 may be configured to determine the proper recipient or recipients of the charge. The server 102 may receive this information from the STB 106. The server 102 may use this information to determine how much a user will be charged.

In an exemplary embodiment, the server 102 may include a customer interface module 202, a content and recipient identification module 204, a recipient communication module 206, a content delivery module 208, and a billing module 210. Modules 202, 204, 206, 208, and 210 are exemplary. The function of modules 202, 204, 206, 208, and 210 may be performed at other modules remote or local to server 102 or STB 106, and the modules 202, 204, 206, 208 and 210 may be combined or separated.

Customer interface module 202 may exist as a software application executing on a STB, which displays the visual manifestation of the interface to a display device. Customer interface module 202 may allow a user to select VOD content and may further allow a user to share selected VOD content with other individuals. Customer interface module 202 may work in conjunction with various other modules such as content and recipient identification module 204. For example, customer interface module may receive information from a user indicating the VOD content to share and the individuals to share VOD content with. Content and recipient identification module 204 may cause the user request to a server where the content may be identified and retrieved for delivery to the user and anyone who the user has selected for sharing purposes. The content and recipient identification module 204 may also process the information input from the user to determine the delivery location for the requested VOD content.

Content delivery module 208 may work in conjunction with content and recipient identification module 204. Specifically, content and recipient identification module 204 may identify the content to be delivered and the location that the content should be delivered to. Content delivery module 208 may then deliver the identified VOD content to the properly identified locations. The content delivery module may exist both at a server 102 and STB 106. The delivery of the content may begin at the server 102 and may be routed to a destination address corresponding to a SIB 106 of a recipient user.

Recipient notification module may operate at the STB of a recipient of shared VOD content. The recipient notification module 204 may work in conjunction with content and recipient identification module 204. For example, the content, once identified, may be delivered to the user and the recipient notification module 204 may provide the recipient with notification—for example, a display device interface message, a text message, a phone call, or another mechanism likely to be successful in quickly alerting the recipient to the shared VOD content—that a user has shared VOD content with the recipient. The recipient notification module 204 may also provide details about the manner that the content can be retrieved.

Billing module 210 may exist at both server 102 and STB 106 and may analyze the user's request for VOD content to determine the appropriate charge. In some embodiments, the purchaser or sharer of VOD content may receive the charge for the entirety of the content. In some embodiments, the cost of the content may be divided between purchaser and the one or more recipient in a predetermined or agreed-upon manner. The price of the purchasing and sharing VOD content may be determined in various different manners. The billing module 210, by way of non-limiting example, may determine the final charge by a formula that ensures that both the purchaser and recipients of the VOD content are charged a fixed amount less than they would have normally been charged had they purchased the content individually. Other calculation methods, such as a method that provided additional discounts based on the number of people that the original purchaser shares the VOD content with, may also be suitable and, again, are provided only by way of non-limiting example.

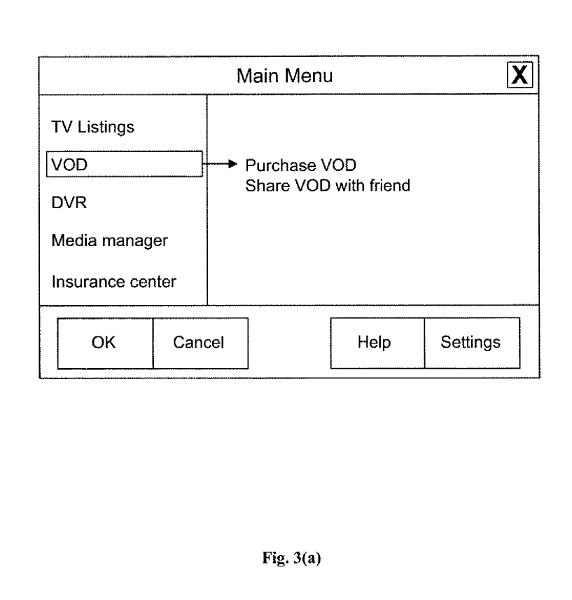

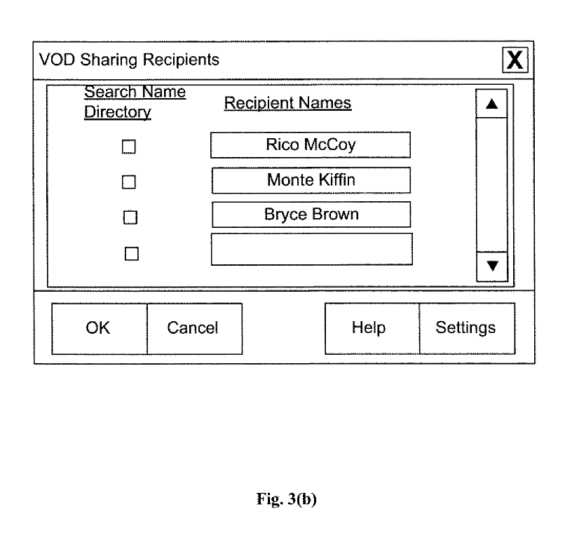

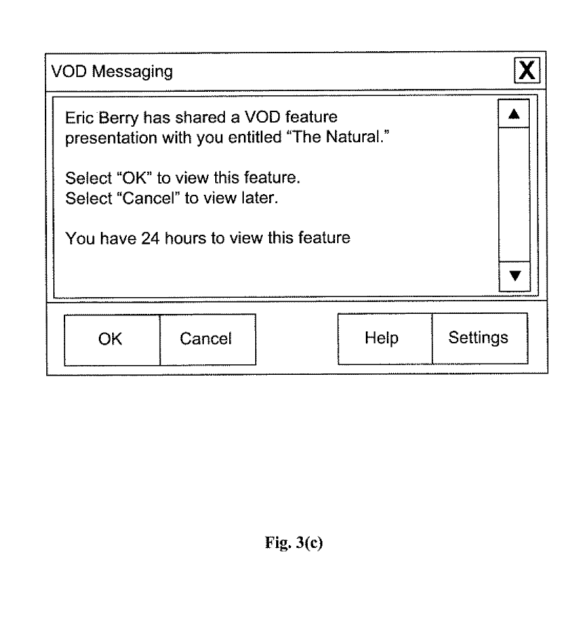

FIG. 3(a) illustrates the appearance of a main menu of a user interface according to a particular embodiment. The main menu may provide the user with the option of deciding, at the outset, whether to purchase VOD content for the user only or whether to share this content with other users. In some embodiments, a purchaser of VOD content may be given the option of sharing the VOD content after the purchaser has viewed the content in its entirety. This may provide a user-purchaser with the opportunity to immediately share video content that the user finds enjoyable.

FIG. 3(b) illustrates the appearance of a user interface for inputting the intended recipients of VOD content according to a particular embodiment. FIG. 3(c) illustrates the appearance of a VOD recipient messaging interface in accordance with exemplary embodiments. The interface shown in FIG. 3(b) may be used by the purchaser of the VOD content who wishes to share the VOD content. In the illustrated interface, a hypothetical VOD purchaser, Eric Berry (shown in FIG. 3(c)), may directly input the names of the intended recipients into the interface. If Eric wants to share VOD content with an individual but is not sure if that individual has a system configured to receive VOD content, Eric may search through the name directory and find out whether it is possible to share VOD content with a particular individual. For example, Eric may know for certain that his friends Rico, Monte, and Bryce have systems configured to receive and view VOD content. Eric may be unsure, however, whether an additional friend, NuKeese, has a configured system. Eric may select the control button next to the input field and perform a search to determine whether NuKeese has a configured system so that he can share VOD content with NuKeese.

Once the VOD content has been shared, the recipients may receive a message indicating that content has been made available to them for viewing. This message may be delivered to the user's display device. The message may be delivered via text message. The message may be delivered via email. Or the message may be delivered via another mechanism suitable to notify the recipient of the shared content.

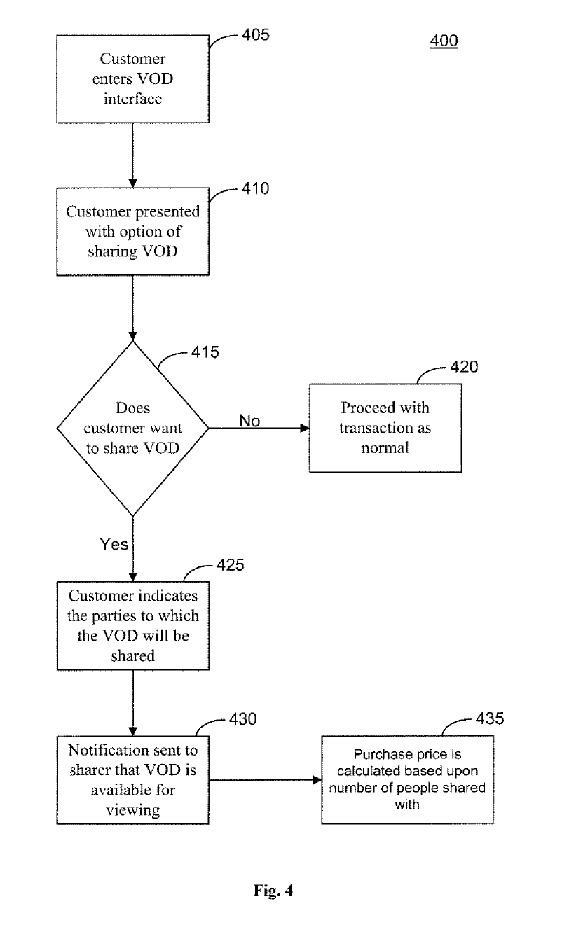

FIG. 4 is a flowchart illustrating a method of sharing Video on Demand content in accordance with an exemplary embodiment.

In an exemplary embodiment, as illustrated at box 405, a user may select VOD content through a VOD user interface. The interface may appear at the display device and the user may indicate selections by navigating the interface using control buttons such as, by way of non-limiting example, a remote control or plugged-in joystick device. The content and organization of the interface may be dictated by information stored in a STB, which may receive content updates from a central server. The display device and STB may be communicatively coupled. Likewise, the STB may be communicatively coupled with a central server through a network.

A user selection of content via the interface may be received by the STB, which may then send this information to a central server. The server may be configured to process the instructions, such as the user selection of a particular VOD content, and retrieve the requested content for subsequent delivery.

In exemplary embodiments, as is illustrated in box 410, the interface may present the user with the option of making a movie selection for personal viewing only, or sharing the selection with other users. Box 420 illustrates that a user who does not wish to share VOD content may complete the VOD purchase transaction as normal.

If the user wants to share the VOD content with others, as is shown in box 425, the user may be given the option of inputting the intended recipients into the interface. In an exemplary embodiment, as is illustrated in FIG. 3(b), the interface may provide a menu where the intended recipients can be listed. In some embodiments, the interface may provide the user with information regarding the cost of sharing VOD content with others. In some embodiments, the total cost of sharing VOD content may be less than the price of each individual separately purchasing the content. As a non-limiting example, if the VOD content is a newly released blockbuster movie that costs four dollars to purchase and view on demand, the additional charge for sharing the blockbuster movie with three additional people may only be ten dollars. In this example, the customers, viewed collectively, saved two dollars from what the normal charge would have been. In some embodiments, a search mechanism may be provided, as is illustrated in FIG. 3(b) for finding potential recipients and ensuring that they have the ability to receive the VOD content.

Box 430 illustrates that after the purchaser shares the VOD content with intended recipients, notification may be sent to the intended recipients indicating that the VOD content is available for viewing. The notification may also include other relevant information, including but not limited to, any time constraints that the recipient has to view the VOD content.

Box 435 illustrates that a purchase price may be calculated based upon the number of people the VOD content has been shared with. Various methodologies may be used to calculate a purchase price. At least three non-limiting examples of different pricing schemes have been discussed in the disclosure above. In some embodiments, the purchase price is provided to the user prior to completing the transaction of sharing the VOD content and delivering it to the STB at the location of the intended recipient.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
providing an interface configured to facilitate user navigation of video on demand selections, wherein the interface is further configured to present a subscriber with the option of sharing video on demand content with other subscribers;
receiving information including information representative of selected multimedia content and information representative of additional delivery destinations for the selected multimedia content;
providing information to the interface indicating a price associated with delivery of the multimedia content to the subscriber and the additional delivery destinations
sending the received information to a server;
receiving the selected multimedia content and information indicating whether the selected multimedia content was delivered to the additional delivery destinations.

2. The method according to claim 1 wherein the option for sharing video on demand content with other subscribers is presented prior to viewing the content.

3. The method according to claim 1, wherein the option of sharing video on demand content with other subscribers is presented after the content has been viewed.

4. The method according to claim 1, wherein the at least one additional delivery destination corresponds to the network address of a subscribers set top box.

5. The method according to claim 4, wherein the information representative of additional delivery destinations for the selected multimedia content is the names of the subscribers.

6. The method according to claim 4, wherein the information representative of additional delivery destinations for the selected multimedia content is the network address of a subscriber's set top box.

7. The method according to claim 6, wherein the network address is retrieved from an internal subscriber directory.

8. The method according to claim 1, wherein the price associated with the delivery of the multimedia content is less than the price for a single purchase multiplied by the number of destinations the content is being delivered to.

9. The method according to claim 8, wherein the price per delivered multimedia content decreases as the number of delivery destinations increases.

10. A method, comprising:
receiving electronic information including information identifying multimedia content and information identifying primary delivery location and additional delivery locations;
processing the information identifying additional delivery locations to determine addresses for the additional delivery locations;
retrieving identified multimedia content; and
supplying the retrieved multimedia content to the addresses corresponding to the primary delivery location and the additional delivery locations.

11. The method of claim 10 further comprising delivering a notification to the additional delivery locations.

12. The method according to claim 11, wherein the notification information includes the identity of the purchaser.

13. The method according to claim 11, wherein the notification information includes time constraint information for viewing the multimedia content.

14. A computer readable media comprising code to perform the acts of the method of claim 1.

15. A computer readable media comprising code to perform the acts of the method of claim 10.

16. A system, comprising:
a client device communicatively coupled to a network;
a processor communicatively coupled to the client device, wherein the processor is configured to:
provide an interface configured to facilitate user navigation of video on demand selections, wherein the interface is further configured to present a subscriber with the option of sharing video on demand content with other subscribers;
receive information including information representative of selected multimedia content and information representative of additional delivery destinations for the selected multimedia content;
provide information to the interface indicating a price associated with delivery of the multimedia content to the subscriber and the additional delivery destinations
send the received information to a server;
receive the selected multimedia content and information indicating whether the selected multimedia content was delivered to the additional delivery destinations.

17. The system according to claim 16 wherein the option for sharing video on demand content with other subscribers is presented prior to viewing the content.

18. The system according to claim 16, wherein the option of sharing video on demand content with other subscribers is presented after the content has been viewed.

19. The method according to claim 16, wherein the at least one additional delivery destination corresponds to the network address of a subscribers set top box.

20. A device, comprising:
a customer interface module configured to provide an interface allowing a consumer to select and share VOD content;
a content and recipient identification module configured to receive information from a consumer identifying VOD content and at least one other individual besides the consumer, and use this information to retrieve the identified VOD content and determine at least one delivery location;
a billing module configured to determine the appropriate charge for the VOD, wherein the charge varies in accordance with the number of individuals that the VOD content is shared with.
